(19) United States
(12) Patent Application Publication
(10) Pub. No.: US 2017/0220147 A1
(43) Pub. Date: Aug. 3, 2017

(54) METHOD OF AMPLIFYING TOUCH CONTROL SIGNAL AND TOUCH CONTROL DEVICE USING THE SAME

(71) Applicant: EVERDISPLAY OPTRONICS (SHANGHAI) LIMITED, SHANGHAI (CN)

(72) Inventor: FENG-SHUEN HUANG, SHANGHAI (CN)

(73) Assignee: EVERDISPLAY OPTRONICS (SHANGHAI) LIMITED, SHANGHAI (CN)

(21) Appl. No.: 15/165,442

(22) Filed: May 26, 2016

(30) Foreign Application Priority Data
Feb. 2, 2016 (CN) 201610074496.6

(51) Int. Cl. G06F 3/044

(52) U.S. Cl. CPC G06F 3/044

(57) ABSTRACT

The present disclosure provides a method of amplifying a touch control signal and a touch control device, applied to a touch control panel having a plurality of sensing points, including: acquiring capacitance values of at least one row of the sensing points of the touch control panel, and performing at least one round of amplifying steps, wherein each round of the amplifying steps includes subtracting a preset capacitance reference value from the capacitance value of each of the sensing points to obtain a capacitance difference value, and taking a product of amplifying the capacitance difference value by K times as a new capacitance value of the sensing point, where K is any number greater than or equal to 1. The method and the touch control may increase SNR effectively and improve sensitivity of the touch control panel.

### CROSS-REFERENCE TO RELATED APPLICATIONS

This application is based upon and claims priority to Chinese Patent Application No. 201610074496.6, filed on Feb. 2, 2016, the entire contents thereof are incorporated herein by reference.

### TECHNICAL FIELD

The present disclosure generally relates to the field of touch control identification, particularly to a method of amplifying a touch control signal and a touch control device using the method in integrated equipment of a touch control panel and a liquid crystal panel.

### BACKGROUND

A technology principle of the touch control panel is, when a finger or other medium comes into contact with a screen, to measure voltage, current, sound waves or infrared ray or the like according to different sensing manners, so as to detect a coordinate position of a touch press point. For example, a resistive touch control panel is to calculate a position of a press point by a potential difference between a top and bottom electrodes, so as to detect a position of the touch control point. The capacitive touch control panel is to detect the coordinate according to a current or voltage generated by capacitance change. The capacitance change is generated by static electricity coupling between an arranged transparent electrode and the human body.

Compared with a traditional method that the capacitive touch panel is disposed on the liquid crystal panel, researches of integrating functions of the capacitive touch panel with the liquid crystal panel begin to prevail. The integration of the touch panel and the liquid crystal panel includes an “In-cell” method and an “On-cell” method. The “In-cell” method refers to a method that functions of the touch panel are embedded into liquid crystal pixels. The “On-cell” method refers to a method that functions of the touch panel are embedded between a colored filter sheet substrate and a polarizer.

However, in the “In-cell” manner, capacitors of the touch panel may be interfered with by an OLED (Organic Light-Emitting Diode) circuit, which results in that capacitance of a whole line may be raised much in some cases, such that a touch control point cannot be accurately identified. Noise is caused when OLEDs playing pictures. FIG. 1 is a schematic diagram of module connections of a capacitive touch control device in the prior art. As shown in FIG. 1, a driving circuit 2′ and a sensing circuit 3′ are provided around the touch control panel 1′ respectively. Driving lines 21′ and sensing lines 31′ are provided on the touch control panel 1′. Capacitors are provided between the driving lines and the sensing lines correspondingly. The driving circuit 2′ drives the driving lines on the touch control panel 1′ by driving signals Si, where i equals 1, 2, 3 . . . , and so on. The sensing circuit 3′ senses sensing signals Li of the sensing line on the touch control panel 1′, where i equals 1, 2, 3 . . . , and so on. Conductor lines in a first direction (X direction) connected with the driving circuit 2′ on the touch control panel 1′ are referred to as the driving lines 21′. Conductor lines in a second direction (Y direction) connected with the sensing circuit 3′ on the touch control panel 1′ are referred to as the sensing lines 31′. Capacitors are connected between the driving lines 21′ and the sensing lines 31′ correspondingly. In a preceding half period of each time period, the driving circuit 2′ drives the conductor lines 21′ in the first direction and uses a voltage to charge the capacitors. A finger of a user may press on a press position A. In a later half period of each time period, the sensing circuit 3′ sense voltages of all the conductor lines 31′ in the second direction, so as to acquire n pieces of data. After m time periods, m×n pieces of data may be acquired.

In the prior art, the SNR (Signal Noise Ratio) of the touch control panel is too low. With respect to this, a method of amplifying a touch control signal and a touch control device using the method are provided.

### SUMMARY

Aiming at at least a part of defects in the prior art, the present disclosure aims to provide a method of amplifying a touch control signal and a touch control device using the method. It overcomes at least a part of difficulty in the prior art, increases SNR effectively, and improves sensitivity of the touch control panel.

According to an aspect of the present disclosure, there is provided a method of amplifying a touch control signal, applied to a touch control panel having a plurality of sensing points, including: acquiring capacitance values of at least one row of the sensing points of the touch control panel, and performing at least one round of amplifying steps, wherein each round of the amplifying steps includes:

subtracting a preset capacitance reference value from the capacitance value of each of the sensing points, to obtain a capacitance difference value, and taking a product of amplifying the capacitance difference value by K times as a new capacitance value of the sensing point, where K is any number greater than or equal to 1.

For example, at least one round of the amplifying steps further includes setting the capacitance difference values smaller than 0 among the capacitance difference values of the sensing points to zero.

For example, a last round of the amplifying steps includes setting the capacitance difference values smaller than 0 among the capacitance difference values of the sensing points to zero.

For example, the preset capacitance reference value is an average of the capacitance values of all the sensing points.

For example, the preset capacitance reference value is a median value among the capacitance values of all the sensing points sorted from big to small.

For example, the preset capacitance reference value is a preset threshold value.

For example, the method of amplifying the touch control signal includes two rounds of the amplifying steps, wherein

a first-round amplifying step includes: subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point: and

a second-round amplifying step includes: subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point.

For example, in the first-round amplifying step, a product of amplifying the first-round capacitance difference value by triple times is taken as a first-round capacitance value of the sensing point.

For example, in the second-round amplifying step, a product of amplifying the second-round capacitance difference value by quadruple times is taken as a second-round capacitance value of the sensing point.

For example, the touch control panel is a capacitive touch control panel.

According to another aspect of the present disclosure, there is further provided a touch control device, configured to implement the above method of amplifying a touch control signal, including:

a touch control panel, provided with driving lines, sensing lines and capacitors being disposed between the driving lines and the sensing lines;

a driving circuit, configured to drive the driving lines on the touch control panel;

a sensing circuit, configured to sense signals of the sensing line on the touch control panel correspondingly; and

a processing unit, configured to connect the sensing line, acquire capacitance values of at least one row of the sensing points of the touch control panel, and perform at least one round of the amplifying steps, wherein each round of the amplifying steps includes subtracting the preset capacitance reference value from the capacitance value of each of the sensing points, to obtain the capacitance difference value, and taking the product of amplifying the capacitance difference value by K times as a new capacitance value of the sensing point, where K is any number greater than or equal to 1.

For example, at least one round of the amplifying steps further includes setting the capacitance difference values smaller than 0 among the capacitance difference values of the sensing points to zero.

For example, a last round of the amplifying steps includes setting the capacitance difference values smaller than 0 among the capacitance difference values of the sensing points to zero.

For example, the preset capacitance reference value is an average of the capacitance values of all the sensing points.

For example, the preset capacitance reference value is a median value among the capacitance values of all the sensing points sorted from big to small.

For example, the preset capacitance reference value is a preset threshold value.

For example, the processing unit performs two rounds of the amplifying steps on the capacitance value of each of the sensing points, wherein

a first-round amplifying step includes subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point; and

a second-round amplifying step includes subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point.

For example, in the first-round amplifying step, a product of amplifying the first-round capacitance difference value by triple times is taken as a first-round capacitance value of the sensing point.

For example, in the second-round amplifying step, a product of amplifying the second-round capacitance difference value by quadruple times is taken as a second-round capacitance value of the sensing point.

For example, the touch control panel is a capacitive touch control panel.

The method of amplifying a touch control signal and the touch control device using the method provided according to the present disclosure may increase SNR effectively and improve sensitivity of the touch control panel.

### BRIEF DESCRIPTION OF THE DRAWINGS

The non-restrictive embodiments will be described in detail with reference to following accompanying drawings, through which other features, objects and advantages of the present disclosure will become more apparent.

FIG. 1 is a schematic diagram of module connection of a capacitive touch control device in the prior art;

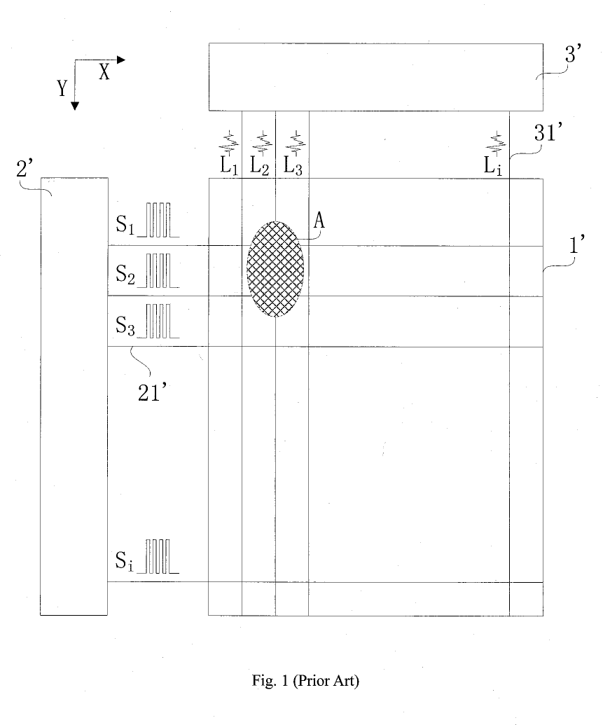

FIG. 2 is a schematic diagram of module connection of a touch control device according to the present disclosure;

FIG. 3 is a flow chart of a method of amplifying a touch control signal according to the present disclosure;

FIG. 4 is a histogram of capacitance values of sensing points of a touch control panel according to the present disclosure;

FIG. 5 is a comparison diagram of capacitance values of sensing points of a touch control panel through first-round amplification according to the present disclosure; and

FIG. 6 is a comparison diagram of capacitance values of sensing points of a touch control panel through second-round amplification according to the present disclosure.

### LISTING OF REFERENCE SIGNS

1′ touch control panel
2′ driving circuit
21′ driving lines
3′ sensing circuit
31′ sensing lines
1 touch control panel
2 driving circuit
21 driving lines
3 sensing circuit
31 sensing lines
4 processing unit
A press position
Bi capacitance values corresponding to the sensing signals
Di first-round capacitance difference values
Ei first-round capacitance values
Gi second-round capacitance difference values
Hi second-round capacitance values

### DETAILED DESCRIPTION

The exemplary implementations of the present disclosure will now be described more fully with reference to the accompanying drawings. However, the exemplary implementations can be implemented in various forms and should not be understood as being limited to the implementations set forth herein; instead, these implementations are provided so that this disclosure will be thorough and complete, and the conception of exemplary implementations will be fully conveyed to those skilled in the art. In the drawings, the same reference signs denote the same or similar structures, thus their detailed description will be omitted.

In addition, the described features, structures or characteristics may be combined in one or more embodiments in any suitable manner. In the following description, numerous specific details are provided so as to allow a full understanding of the embodiments of the present disclosure. However, those skilled in the art will recognize that the technical solutions of the present disclosure may be practiced without one or more of the specific details; or other methods, components, materials and so on may be used. In other cases, well-known structures, materials or operations are not shown or described in detail to avoid obscuring various aspects of the present disclosure.

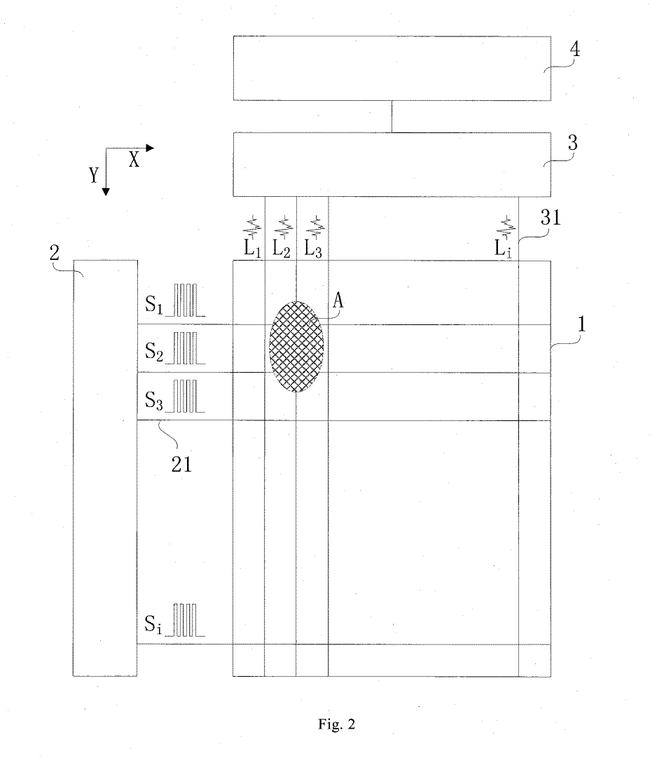

As shown in FIG. 2, a touch control panel of the present disclosure, configured to implement a method of amplifying a touch control signal of the present disclosure, includes: a touch control panel 1, a driving circuit 2, a sensing circuit 3 and a processing unit 4. The driving circuit 2 and the sensing circuit 3 are provided around the touch control panel 1 respectively. The processing unit 4 is connected to the sensing circuit 3. For example, the touch control panel 1 may be a capacitive touch control panel. Driving lines 21 and sensing lines 31 are provided on the touch control panel 1. Capacitors are provided between the driving lines and the sensing lines correspondingly. The driving circuit 2 drives the driving lines on the touch control panel 1 by driving signals Si, where i equals 1, 2, 3 . . . , and so on. The sensing circuit 3 senses sensing signals Li of the sensing lines on the touch control panel 1, where i equals 1, 2, 3 . . . , and so on. Conductor lines in a first direction (X direction) connected with the driving circuit 2 on the touch control panel 1 are referred to as the driving lines 21. Conductor lines in a second direction (Y direction) connected with the sensing circuit 3 on the touch control panel 1 are referred to as the sensing lines 31. Capacitors are connected between the driving lines 21 and the sensing lines 31 correspondingly. In a preceding half period of each time period, the driving circuit 2 drives the conductor lines 21 in the first direction and uses a voltage to charge the capacitors. A finger of a user may press on a press position A. In a later half period of each time period, the sensing circuit 3 senses voltages of all the conductor lines 31 in the second direction, so as to acquire n pieces of data. After m time periods, m×n pieces of data may be acquired. The processing unit 4 is connected to the sensing lines 31, acquires capacitance values of at least one row of the sensing points of the touch control panel 1, and performs at least one round of amplifying steps, so as to increase SNR. Each round of the amplifying steps includes subtracting a preset capacitance reference value (a capacitance reference value in each round of the amplifying steps may be set according to actual requirement in the round, and a capacitance reference value in each round may be different from that in other rounds) from the capacitance value of each of the sensing points, to obtain a capacitance difference value, and taking a product of amplifying the capacitance difference value by K times as a new capacitance value of the sensing point, where K may be any number greater than or equal to 1. The capacitance reference value in each round of the amplifying steps may be the same as or different from that in other rounds. According to the present embodiment, the touch control panel 1 may be a capacitive touch control panel, but not limited to this.

Since the processing unit 4 mainly calculates or post-processes points of a region (i.e., a touched region) with the largest capacitance value in the touch control panel 1 and capacitance values of other points just play a reference role, capacitance values of points (i.e., a untouched region) with apparently low capacitance values may be set to zero according to the present disclosure. For example, at least one round of the amplifying steps further includes setting the capacitance difference values smaller than 0 among the capacitance difference values of the sensing points to zero, but not limited to this. For example, a last round of the amplifying steps includes setting the capacitance difference values smaller than 0 among the capacitance difference values of the sensing points to zero, so as to reduce calculation amount.

According to the present embodiment, the preset capacitance reference value is an average of the capacitance values of all the sensing points, or a median value among the capacitance values of all the sensing points sorted from big to small, but not limited to this. The preset capacitance reference value may also be an artificially preset threshold value according to actual requirement.

According to the present embodiment, the processing unit 4 performs two rounds of the amplifying steps on the capacitance values of the sensing points. A first-round amplifying step includes subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point. A second-round amplifying step includes subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point. According to the present embodiment, in the first-round amplifying step, a product of amplifying the first-round capacitance difference value by triple times is taken as a first-round capacitance value of the sensing point. In the second-round amplifying step, a product of amplifying the second-round capacitance difference value by quadruple times is taken as a second-round capacitance value of the sensing point.

According to an aspect of the present disclosure, there is provided a method of amplifying a touch control signal, applied to a touch control panel having a plurality of sensing points, including: acquiring capacitance values of at least one row of the sensing points of the touch control panel, and performing at least one round of amplifying steps. Each round of the amplifying steps includes subtracting a preset capacitance reference value (a capacitance reference value in each round of the amplifying steps may be set according to actual requirement in the round, and a capacitance reference value in each round may be different from that in other rounds) from the capacitance value of each of the sensing points, to obtain a capacitance difference value, and taking a product of amplifying the capacitance difference value by K times as a new capacitance value of the sensing point, where K may be any number greater than or equal to 1. The capacitance reference value in each round of the amplifying steps may be the same as or different from that in other rounds. According to the present embodiment, the touch control panel may be a capacitive touch control panel, but not limited to this.

Since the processing unit 4 mainly calculates points of a region (i.e., a touched region) with the largest capacitance value in the touch control panel 1 and capacitance values of other points just play a reference role, capacitance values of points (i.e., a untouched region) with apparently low capacitance values may be set to zero according to the present disclosure. For example, at least one round of the amplifying steps further includes setting the capacitance difference values smaller than 0 among the capacitance difference values of the sensing points to zero, but not limited to this. For example, a last round of the amplifying steps includes setting the capacitance difference values smaller than 0 among the capacitance difference values of the sensing points to zero, so as to reduce calculation amount.

According to the present embodiment, the preset capacitance reference value is an average of the capacitance values of all the sensing points, or a median value among the capacitance values of all the sensing points sorted from big to small, but not limited to this. The preset capacitance reference value may also be an artificially preset threshold value according to actual requirement.

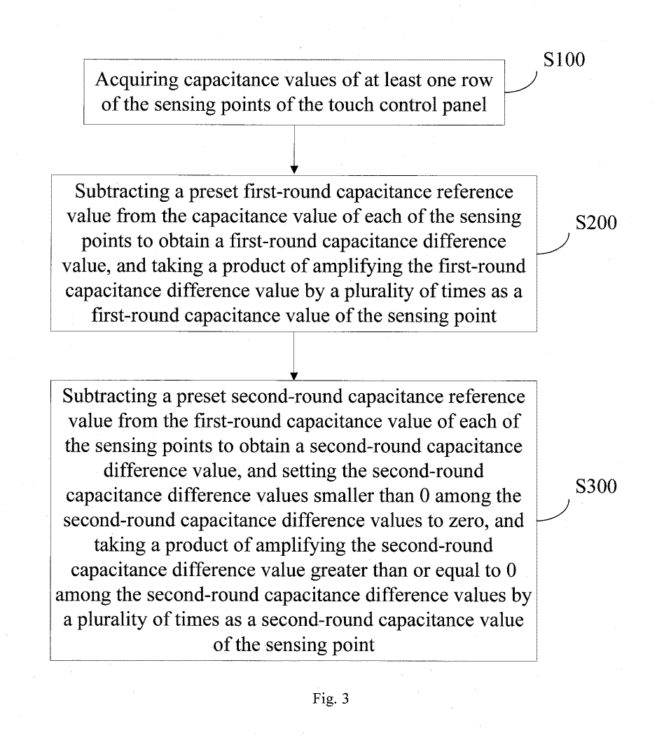

FIG. 3 is a flow chart of the above method of amplifying a touch control signal according to the present disclosure. As shown in FIG. 3, the method of amplifying a touch control signal according to the present disclosure may include following steps:

S100: acquiring capacitance values of at least one row of the sensing points of the touch control panel;

S200: subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point; and

S300: subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point.

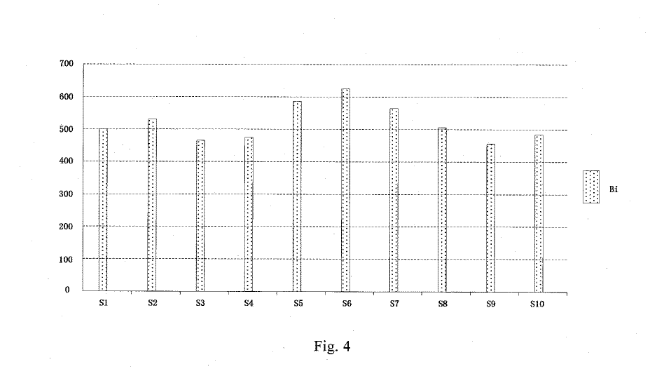

FIG. 4 is a histogram of capacitance values of sensing points of a touch control panel according to the present disclosure. Referring to FIG. 4, firstly, capacitance values Bi of at least one row of the sensing points of the touch control panel are acquired, where i equals 1, 2, 3 . . . (referring to Table 1). According to the present embodiment, the capacitance reference value is a digit converted from an actual capacitance value by a touch control IC (Integrated Circuit), which is depends on the ability of the touch control IC. Assuming that the touch control IC can operate in a unit of 5 pF, a digit 1 represents that a detected capacitance value is 0-4 pF, a digit 2 represents that a detected capacitance value is 5-9 pF, and so on, but not limited to this. The following capacitance reference values are expressed in a manner the same as the above, which will not be repeatedly illustrated herein.

TABLE 1

| sensing lines | S1 | S2 | S3 | S4 | S5 | S6 | S7 | S8 | S9 | S10 |
|---|---|---|---|---|---|---|---|---|---|---|
| capacitance values Bi | 504 | 533 | 467 | 478 | 590 | 631 | 566 | 509 | 459 | 488 |
| corresponding to | | | | | | | | | | |
| sensing signals Li | | | | | | | | | | |

Two rounds of the amplifying steps are performed after capacitance values Bi corresponding to all the sensing signals Li are acquired.

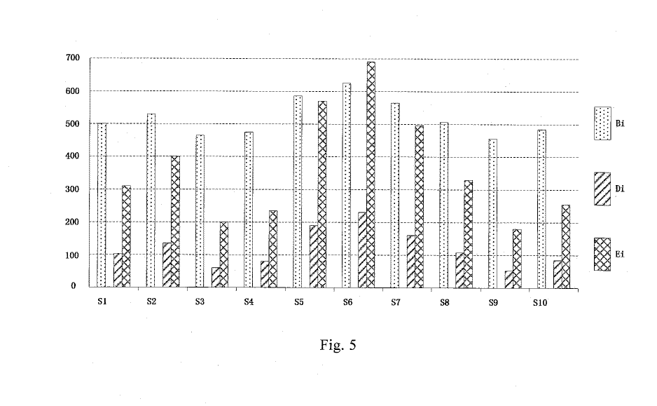

FIG. 5 is a comparison diagram of capacitance values of sensing points of a touch control panel through first-round amplification according to the present disclosure. Referring to FIG. 5, a first-round capacitance reference value C is preset for the first-round amplifying step. The first-round amplifying step includes subtracting the first-round capacitance reference value C from the capacitance value Bi of each of the sensing points respectively, to obtain first-round capacitance difference values Di, i.e.,

Di=Bi−C.

Products of amplifying the first-round capacitance difference values Di by triple times respectively, as first-round capacitance values Ei of the respective sensing points, where i equals 1, 2, 3 . . . (referring to Table 2), i.e.,

Ei=3×Di=3×(Bi−C).

TABLE 2

| sensing line | S1 | S2 | S3 | S4 | S5 | S6 | S7 | S8 | S9 | S10 |
|---|---|---|---|---|---|---|---|---|---|---|
| capacitance values Bi | 504 | 533 | 467 | 478 | 590 | 631 | 566 | 509 | 459 | 488 |
| corresponding to sensing | | | | | | | | | | |
| signals Li | | | | | | | | | | |
| first-round capacitance | 400 | | | | | | | | | |
| reference value C | | | | | | | | | | |
| first-round capacitance | 104 | 133 | 67 | 78 | 190 | 231 | 166 | 109 | 59 | 88 |
| difference values Di | | | | | | | | | | |
| first-round capacitance | 312 | 399 | 201 | 234 | 570 | 693 | 498 | 327 | 177 | 264 |
| values Ei | | | | | | | | | | |

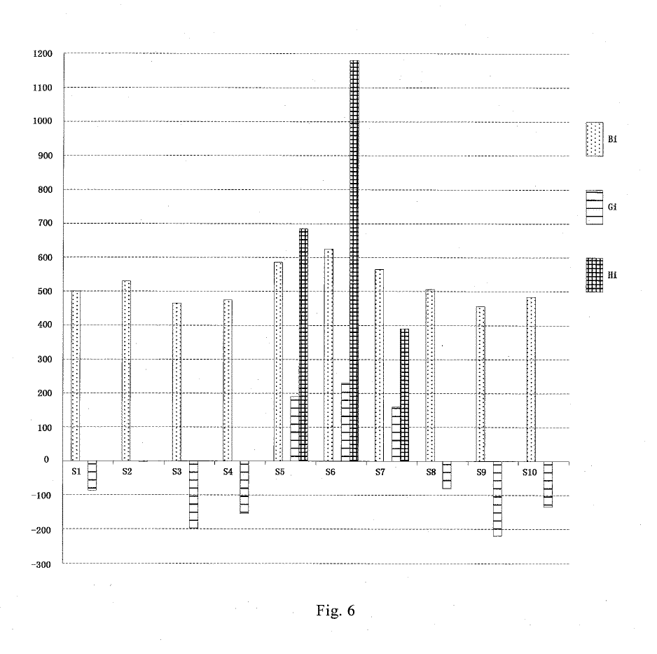

Secondly, FIG. 6 is a comparison diagram of capacitance values of sensing points of a touch control panel through second-round amplification according to the present disclosure. Referring to FIG. 6, a second-round capacitance reference value F is preset for the second-round amplifying step. The second-round amplifying step includes subtracting the second-round capacitance reference value F from the first-round capacitance values Ei of each of the sensing points, to obtain second-round capacitance difference values Gi, where i equals 1, 2, 3 . . . , i.e.,

Gi=Ei−F.

A part of the second-round capacitance difference values Gi smaller than 0 among the second-round capacitance difference values Gi are set to zero, and products of amplifying the second-round capacitance difference values Gi greater than or equal to 0 among the second-round capacitance difference values Gi by quadruple times respectively as second-round capacitance values Hi of the respective sensing points, where i equals 1, 2, 3 . . . , (referring to Table 3), i.e.,

Hi=3×Gi=4×(Ei−F).

TABLE 3

| sensing line | S1 | S2 | S3 | S4 | SS | S6 | S7 | S8 | S9 | S10 |
|---|---|---|---|---|---|---|---|---|---|---|
| capacitance values Bi | 504 | 533 | 467 | 478 | 590 | 631 | 566 | 509 | 459 | 488 |
| corresponding to | | | | | | | | | | |
| sensing signals Li | | | | | | | | | | |
| first-round capacitance | 400 | | | | | | | | | |
| reference value C | | | | | | | | | | |
| first-round capacitance | 104 | 133 | 67 | 78 | 190 | 231 | 166 | 109 | 59 | 88 |
| difference values Di | | | | | | | | | | |
| first-round capacitance | 312 | 399 | 201 | 234 | 570 | 693 | 498 | 327 | 177 | 264 |
| values Ei | | | | | | | | | | |
| second-round capacitance | 400 | | | | | | | | | |
| reference value F | | | | | | | | | | |
| second-round capacitance | −88 | −1 | −199 | −166 | 170 | 293 | 98 | −73 | −223 | −136 |
| difference values Gi | | | | | | | | | | |
| setting second-round | 0 | 0 | 0 | 0 | 170 | 293 | 98 | 0 | 0 | 0 |
| capacitance difference | | | | | | | | | | |
| values Gi to zero | | | | | | | | | | |
| second-round capacitance | 0 | 0 | 0 | 0 | 680 | 1172 | 392 | 0 | 0 | 0 |
| values Hi | | | | | | | | | | |

Though the method of amplifying a touch control signal according to the present disclosure, the touched sensing line may be easily found out and a position of the touched region may also be clearly known. Compared with data of the capacitance values Bi corresponding to the sensing signals Li, SNR of the second-round capacitance values Hi in Table 3 of the present disclosure is significantly increased, and sensitivity of the touch control panel is greatly improved.

To sum up, the method of amplifying a touch control signal and the touch control device using the method provided according to the present disclosure may increase SNR effectively and improve sensitivity of the touch control panel.

Detailed embodiments of the present disclosure are illustrated above. It should note that; the present disclosure is not limited to the above specific implementations. Those skilled in the art may make various transformations or amendments within the protection scope of claims, which does not influence essential content of the present disclosure.

What is claimed is:

1. A method of amplifying a touch control signal, applied to a touch control panel having a plurality of sensing points, comprising:
acquiring capacitance values of at least one row of the sensing points of the touch control panel, and performing at least one round of amplifying steps, wherein each round of the amplifying steps comprises:
subtracting a preset capacitance reference value from the capacitance value of each of the sensing points, to obtain a capacitance difference value, and
taking a product of amplifying the capacitance difference value by K times as a new capacitance value of the sensing point, where K is any number greater than or equal to 1.

2. The method according to claim 1, wherein at least one round of the amplifying steps further comprises setting the capacitance difference values smaller than 0 among the capacitance difference values of the sensing points to zero.

3. The method according to claim 2, wherein a last round of the amplifying steps comprises setting the capacitance difference values smaller than 0 among the capacitance difference values of the sensing points to zero.

4. The method according to claim 1, wherein the preset capacitance reference value is an average of the capacitance values of all the sensing points.

5. The method according to claim 1, wherein the preset capacitance reference value is a median value among the capacitance values of all the sensing points sorted from big to small.

6. The method according to claim 1, wherein the preset capacitance reference value is a preset threshold value.

7. The method according to claim 1, wherein the amplifying steps comprises:
a first-round amplifying step comprising: subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point; and
a second-round amplifying step comprising: subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point.

8. The method according to claim 7, wherein, in the first-round amplifying step, a product of amplifying the first-round capacitance difference value by triple times is taken as a first-round capacitance value of the sensing point.

9. The method according to claim 7, wherein, in the second-round amplifying step, a product of amplifying the second-round capacitance difference value by quadruple times is taken as a second-round capacitance value of the sensing point.

10. The method according to claim 1, wherein the touch control panel is a capacitive touch control panel.

11. A touch control device, comprising:
a touch control panel, provided with driving lines, sensing lines, and capacitors being disposed between the driving lines and the sensing lines correspondingly;
a driving circuit, configured to drive the driving lines on the touch control panel;
a sensing circuit, configured to sense signals of the sensing lines on the touch control panel correspondingly; and
a processing unit, configured to connect the sensing lines, acquire capacitance values of at least one row of the sensing points of the touch control panel, and perform at least one round of the amplifying steps, wherein each round of the amplifying steps comprises:
subtracting the preset capacitance reference value from the capacitance value of each of the sensing points, to obtain the capacitance difference value, and
taking the product of amplifying the capacitance difference value by K times as a new capacitance value of the sensing point, where K is any number greater than or equal to 1.

12. The touch control device according to claim 11, wherein at least one round of the amplifying steps further comprises setting the capacitance difference values smaller than 0 among the capacitance difference values of the sensing points to zero.

13. The touch control device according to claim 12, wherein a last round of the amplifying steps comprises setting the capacitance difference values smaller than 0 among the capacitance difference values of the sensing points to zero.

14. The touch control device according to claim 11, wherein the preset capacitance reference value is an average of the capacitance values of all the sensing points.

15. The touch control device according to claim 11, wherein the preset capacitance reference value is a median value among the capacitance values of all the sensing points sorted from big to small.

16. The touch control device according to claim 11, wherein the preset capacitance reference value is a preset threshold value.

17. The touch control device according to claim 11, wherein the amplifying steps performed by the processing unit comprises:
a first-round amplifying step comprising: subtracting a preset first-round capacitance reference value from the capacitance value of each of the sensing points to obtain a first-round capacitance difference value, and taking a product of amplifying the first-round capacitance difference value by a plurality of times as a first-round capacitance value of the sensing point; and
a second-round amplifying step comprising: subtracting a preset second-round capacitance reference value from the first-round capacitance value of each of the sensing points to obtain a second-round capacitance difference value, and setting the second-round capacitance difference values smaller than 0 among the second-round capacitance difference values to zero, and taking a product of amplifying the second-round capacitance difference value greater than or equal to 0 among the second-round capacitance difference values by a plurality of times as a second-round capacitance value of the sensing point.

18. The touch control device according to claim 17, wherein, in the first-round amplifying step, a product of amplifying the first-round capacitance difference value by triple times is taken as a first-round capacitance value of the sensing point.

19. The touch control device according to claim 17, wherein, in the second-round amplifying step, a product of amplifying the second-round capacitance difference value by quadruple times is taken as a second-round capacitance value of the sensing points.

20. The touch control device according to claim 11, wherein the touch control panel is a capacitive touch control panel.
